(19) United States
(12) Patent Application Publication
(10) Pub. No.: US 2024/0336426 A1
(43) Pub. Date: Oct. 10, 2024

(54) CONTAINER, BEVERAGE OR FOODSTUFF PREPARATION SYSTEM, USE OF SAID CONTAINER AND METHOD OF FORMING A CONTAINER

(71) Applicant: SOCIETE DES PRODUITS NESTLE S.A., Vevey (CH)

(72) Inventor: ALFRED YOAKIM, St-Legier-La Chiesaz (CH)

(21) Appl. No.: 18/579,126

(22) PCT Filed: Jul. 11, 2022
(86) PCT No.: PCT/EP2022/069304

§ 371 Date: Jan. 12, 2024

(30) Foreign Application Priority Data
Jul. 16, 2021 (EP) 21186122.4

(51) Int. Cl. B65D 85/804; A47J 31/36; A47J 31/44; A47J 31/52; B65B 29/02

(52) U.S. Cl. CPC B65D 85/8058; A47J 31/369; A47J 31/4492; A47J 31/525; B65B 29/022

(57) ABSTRACT

A container (6) arranged for containing a precursor material for use with a machine for preparing a beverage and/or foodstuff, the container comprising: a storage portion (58) having an opening for receiving the precursor material; a membrane (56) to close the opening; a flange (60) including an upper surface, an opposed lower surface, and a peripheral edge, and; a machine-readable code (44) storing preparation information for use with a preparation process performed by said machine, wherein the membrane is arranged to extend; over the upper surface, around the peripheral edge, and over the lower surface, wherein the code is arranged on a lower surface portion of the membrane, which adjoins the lower surface.

### TECHNICAL FIELD

The present disclosure relates generally to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine, and; the preparation information is used by the machine to optimise the preparation process in a manner specific to the capsule. In particular, the encoded preparation information may comprise operating parameters selected in the beverage preparation process, including: fluid temperature; fluid pressure; preparation duration, and; fluid volume.

The capsule includes a storage portion for storing the precursor material; a closing member arranged as membrane to close the storage portion, and; a flange formed with the storage portion presents a surface for connection of the membrane. The code is printed to a lower surface of the flange, however the printing process directly onto the flange can be complex.

Therefore, in spite of the effort already invested in the development of said systems further improvements are desirable.

### SUMMARY

The present disclosure provides a container for containing a precursor material for use with a machine for preparing a beverage or foodstuff or a precursor thereof. The container includes: a storage portion, for storage of precursor material, the storage portion having an opening for receiving the precursor material; a closing member (e.g. a membrane) for closing the opening of the storage portion, and; a flange for connecting the storage portion and closing member. The flange including an upper surface, an opposed lower surface, and a peripheral edge. The membrane is arranged to extend: over (including in direct contact with or via an intermediate member) the upper surface; around the peripheral edge, and; over (including in direct contact with or via an intermediate member) the lower surface, of the flange.

In embodiments, the container includes a machine-readable code storing preparation information for use with a preparation process performed by said machine, in which the machine is controlled based on the preparation information to prepare the beverage and/or foodstuff or precursor thereof. In embodiments, the code comprises a plurality of elements, the elements encoding a data portion storing the preparation information, and encoding a finder sequence for locating the data portion. In embodiments, In embodiments, the code is arranged on (including directly on or via an intermediate member) a lower surface portion of the membrane, which adjoins the lower surface.

By arranging the membrane to extend across the upper surface, around the peripheral edge and the lower surface, the flange may be enveloped by the membrane. With such an arrangement the code may be more conveniently formed on the membrane than on the flange directly, for example, before the membrane is attached to the storage portion and when it is arranged in 2-dimmensions. The membrane material may also be more convenient for printing of the code on to. Moreover, the membrane may also provide an improved hermetic seal for the precursor material since it extends around the peripheral edge of the flange.

In embodiments, the membrane is physically connected to at least one of: the upper surface; the lower surface, and; the peripheral edge. As used herein the term “physically connected” may refer to any mechanical coupling, including an adhesive connection; welding; crimping, and; other suitable connection.

In embodiments, the membrane includes formation portions (e.g. weekending portions and/or perforation portions, including slits) arranged on the portion of the membrane adjoining the lower surface, said portions configured to enable expansion and/or contraction and as the membrane is wrapped around said peripheral edge. By implementing said portions the circumferential distance of the membrane can be changed as it is expanded over a rim of the peripheral edge and contracted over the lower portion.

In embodiments, the peripheral edge is circular in cross-section, an a peripheral edge portion of the membrane is arranged to extend around said circular-cross section. As used herein the term “around” in respect of the membrane and peripheral edge may refer to the membrane being able to extend contiguous a substantial portion of the circular periphery of said peripheral edge.

In embodiments, the upper surface and an opposed lower surface of the flange have a radial length of less than 10 mm or 5 mm and the peripheral edge has a radius of less than 2 mm. A minimum length of the flange may be 1 mm and a minimum radius may be 0.25 mm. A material of the membrane may be selected to extend over said radii without overlapping portions. By avoiding overlapping portions, e.g. wrinkles, a hermetic seal may be maintained, which could otherwise cause degradation of the precursor material.

In embodiments, a material of the membrane is plastic based. By implementing a plastic based material, the membrane may be wrapped around the flange without being damaged. Examples of suitable membranes can be derived from the teachings disclosed herein and examples relating to the containers and/or closing members. Suitable constructional and/or operational details are for instance disclosed in EP2569230.

In embodiments, a material of the membrane has a thickness of 0.5-3 mm. By implementing a of said thickness material, the membrane may be wrapped around the flange without being damaged.

In embodiments, a peripheral edge portion of the membrane comprises the code. By arranging the membrane on the peripheral edge, the code may be read from a range of angles depending on the configuration of the machine.

In embodiments, the code is arranged to be read as the container is rotated about an axis of rotation. In embodiments, the elements are arranged on a circumferentially extending virtual line. By arranging said elements to be intersected by a virtual line, they can be read as a code reader is rotated relative said line.

The present disclosure provides a membrane for attachment to a container for containing a precursor material for use with a machine for preparing a beverage and/or foodstuff or a precursor thereof, the membrane comprising a code comprising any feature of the code of the preceding embodiments or another embodiment disclosed herein.

The present disclosure provides a system comprising the container of any preceding embodiment or another embodiment disclosed herein and a machine for preparing a beverage and/or foodstuff or a precursor thereof.

In embodiments, the machine includes: a code reading system to read the code of the container; a processing unit for processing the precursor material of the container, and; electrical circuitry to control the processing unit based on preparation information read from the code. In embodiments, the processing unit includes a container processing unit and a fluid processing system, and; the electrical circuitry is arranged to control the container processing unit and fluid processing system based on the preparation information read from the code. In embodiments, the processing unit is arranged as a loose material processing unit, and; the electrical circuitry is arranged to control the loose material processing unit to process loose precursor material dispensed from the container or arranged in the container based on the preparation information read from the code.

In embodiments, the code reading system is arranged to read the code as the container is rotated about an axis of rotation, and the processing unit is arranged to process the precursor material as the container is rotated about said axis of rotation. Code reading and precursor material processing may be executed concurrently or consecutively.

The present disclosure provides use of the container of any preceding embodiment or another embodiment disclosed herein for a machine for preparing a beverage and/or foodstuff or a precursor thereof.

The present disclosure provides, a method of forming a container for containing a precursor material for use with a machine for preparing a beverage and/or foodstuff, the method comprising: arranging a membrane over an upper surface of a flange that is connected to a storage portion; wrapping the membrane around a peripheral edge of the flange, said peripheral edge adjoining the upper surface; arranging the membrane over a lower surface of the flange, said lower surface adjoining the peripheral edge, and; connecting the membrane to the flange.

In embodiments, the method includes forming the code on the membrane before or after the membrane is connected to the flange. By forming the code on the membrane after it has been connected to the flange, it may be ensured that the code is arranged on the container in the desired position in spite of any misalignment on the membrane.

The method may implement the features of any preceding embodiment, or another embodiment disclosed herein.

The present disclosure provides a container formed by the method of any preceding embodiment, or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff or a precursor thereof.

FIG. 2 is a block system diagram showing an embodiment machine of the system of FIG. 1.

FIG. 3 is an illustrative diagram showing an embodiment fluid conditioning system of the machine of FIG. 2.

FIGS. 4A and 4B and 5 are illustrative diagrams showing an embodiment container processing system of the machine of FIG. 2.

FIG. 6 is an illustrative diagram showing an embodiment machine of FIG. 2, which comprises a loose material processing unit.

FIG. 7 is a block diagram showing embodiment control electrical circuitry of the machine of FIG. 2.

FIG. 8 is an illustrative diagram showing embodiment container of the system of FIG. 1.

FIG. 9 is flow diagram showing an embodiment preparation process, which is performed by the system of FIG. 1.

FIG. 10 is a magnified view showing a code of the container of FIG. 8.

FIG. 11 is a magnified view showing a flange and a closing member of the container of FIGS. 8 and 10.

FIG. 12 is a magnified view showing closing member of the container of FIG. 11.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a closing member, e.g. a membrane, for closing the container. The container may have various forms, including one or more of: frustoconical; cylindrical; disk; hemispherical; packet; other like form. The container may be formed from various materials, such as metal or plastic or a combination thereof. The material may be selected such that it is: food-safe; it can withstand the pressure and/or temperature of a preparation process. The container may be defined as a capsule, wherein a capsule may have an internal volume of 20-100 ml. The capsule includes a coffee capsule, e.g. a Nespresso® capsule (including a Classic, Professional, Vertuo, Dolce Gusto or other capsule). The container may be defined as a receptacle, wherein a receptacle may have an internal volume of 150-350 ml. The receptacle is typically for end user consumption therefrom, and includes a pot, for consumption via an implement including a spoon, and a cup for drinking from. The container may be defined as a packet, wherein the packet is formed from a flexible material, including plastic or foil. A packet may have an internal volume of 150-350 ml or 200-300 ml or 50-150 ml.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid; a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder, powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to a change in a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material. The processing unit may have any suitable implementation, including a container processing unit or a loose material processing unit.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material from a repository, processes by dissolution and dispenses it into a receptacle), and: other like unit.

As used herein, the term “loose material processing unit” may refer to an arrangement that can process loose material of a pre-precursor material to a precursor material. The loose material processing unit may be arranged to process the pre-precursor material by one of more of the following: heating; cooling; grinding; mixing; soaking; conditioning; other processing step. The loose material may be supplied to the loose material processing unit in a container, from which it is extracted and processed.

As used herein, the term “preparation process” may refer to a process to prepare a beverage or foodstuff from a precursor material or to prepare a pre-precursor material from precursor material. A preparation process may refer to the processes electrical circuitry executes to control the container processing unit to process said precursor or pre-precursor material.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to storage medium that encodes preparation information. The code may be an optically readable code, e.g. a bar code. The code may be formed of a plurality of units, which can be referred to as elements or markers.

As used herein, the term “preparation information” may refer to information related to a preparation process. Depending on the implementation of the processing unit said information may vary. The parameters that may be associated container processing unit that comprises a fluid processing system, can include one or more of: fluid pressure; fluid temperature; mass/volumetric flow rate; fluid volume; filtering/purification parameters for the fluid; carbonation parameters for the fluid. The parameters that may be associated container processing unit that comprises a loose material processing unit, can include one or more of: grinding parameters, including intensity; heating temperature. More general parameters can include one or more: container geometric parameters, e.g. shape or volume; the type of precursor; phase identifier, for when a preparation process is split into a series of phases, whereby each phase comprises a set of one or more of any of the aforesaid parameters; duration, including phase duration (e.g. a duration for applying the parameters of a phase or any of the aforementioned parameters generally; and a container identifier, which may for example be used to monitor container consumption for the purpose of container re-ordering or look-up of information from the server system; an expiry date, a recipe identifier, which may be used to lookup a recipe stored on the memory of the machine for use with the container.

### [General System Description]

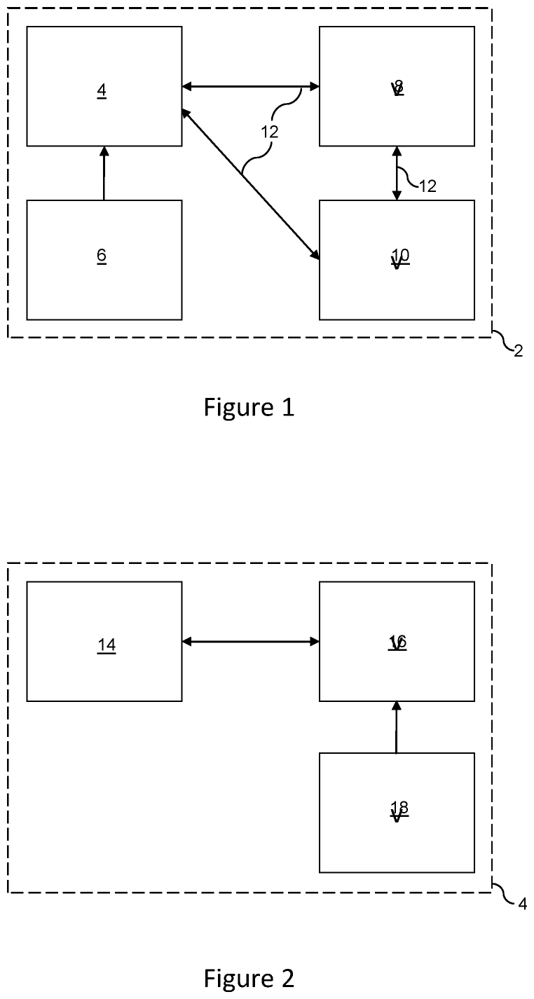

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### [Machine]

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### [First Example of Processing Unit]

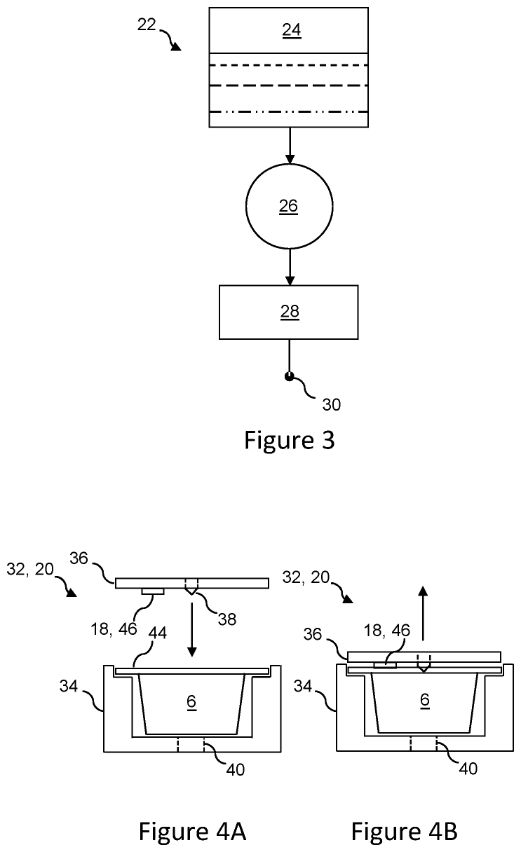

Referring to FIGS. 2 and 3, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### [Fluid Conditioning System]

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump); the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### [Container Processing Unit]

The container processing unit 20 can be implemented with a range of configurations, as illustrated in examples 1-6 below:

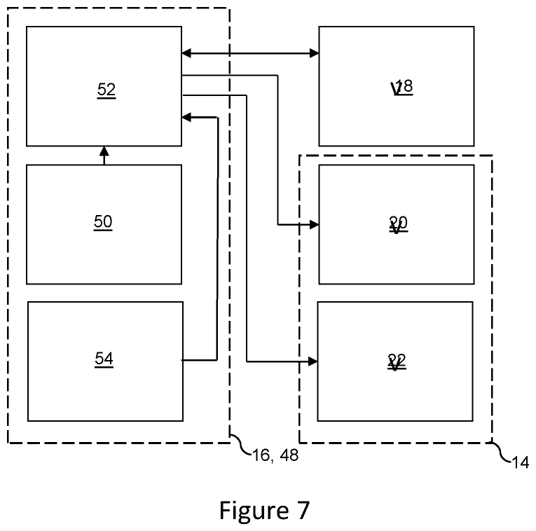

Referring to FIGS. 4A and 4B, a first example of the container processing unit 20 is for processing of a container arranged as a capsule 6 (a suitable example of a capsule is provided in FIG. 7, which will be discussed) to prepare a beverage. The container processing unit 20 is configured as an extraction unit 32 to extract the beverage from the capsule 6. The extraction unit 32 includes a capsule holding portion 34 and a closing portion 36. The extraction unit 32 is movable to a capsule receiving position (FIG. 4A), in which capsule holding portion 34 and a closing portion 36 are arrange to receive a capsule 6. The extraction unit 32 is movable to a capsule extraction position (FIG. 4B), in which the capsule holding portion 34 and a closing portion 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 to inject the conditioned fluid into the capsule 6 in the capsule extraction position, typically under high pressure. A beverage outlet 40 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C.) fluid to the precursor material within the capsule 6. The pressure is increased over a predetermined amount of time until a pressure of a rupturing portion (not illustrated in FIG. 4A, 4B) of the capsule 6 is exceeded, which causes rupture of said portion and the beverage to be dispensed to the beverage outlet 40.

In variant embodiments, which are not illustrated, although the injection head and beverage outlet are illustrated as arranged respectively on the closing portion and capsule holding portion, they may be alternatively arranged, including: the injection head and beverage outlet are arranged respectively on the capsule holding portion and closing portion; or both on the same portion. Moreover, the extraction unit may include both parts arranged as a capsule holding portion, e.g. for capsules that are symmetrical about the flange, including a Nespresso® Professional capsule.

Examples of suitable extraction units are provided in EP 1472156 A1 and in EP 1784344 A1, which are incorporated herein by reference, and provide a hydraulically sealed extraction unit.

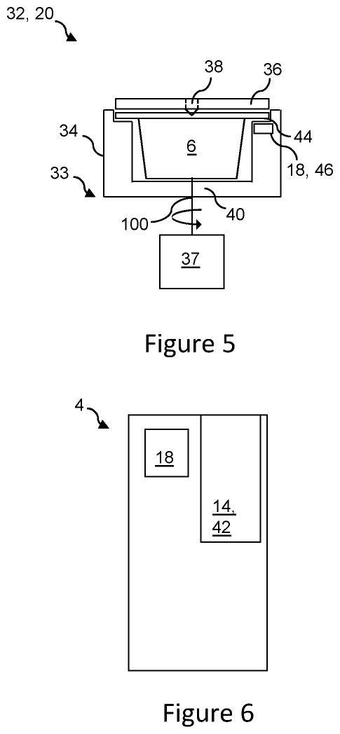

Referring to FIG. 5, in a second example of the container processing unit 20, the extraction unit 32 is as described for the first example, however the extraction unit 32 operates at a lower fluidic pressure and by centrifugation. In particular, the extraction unit 32 includes a rotation mechanism 33 that includes a capsule holing portion 34 to hold the capsule 6 and a drive system 37 to rotate said capsule holder 35.

The outlet 30 of the fluid conditioning system 22 is arranged as on the closing portion 36 as an injection head 38 to inject the conditioned fluid into a centre of the capsule 6 through a closing member of the capsule 6 as will be discussed. The rotation mechanism 33 rotates the capsule to effect transmission of the conditioned fluid radially outwards through precursor material in the capsule 6 and out through peripheral arranged puncture points (not illustrated) in the closing member. An example of a suitable capsule is a Nespresso® Vertuo capsule. A suitable example is provided in EP 2594171 A1, which is incorporated herein by reference.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a containment portion of the capsule. An example of a suitable capsule is a Nespresso® Dolce Gusto capsule. Examples of suitable extraction units are disclosed in EP 1472156 A1 and in EP 1784344 A1, which are incorporated herein by reference.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1, which is incorporated herein by reference.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle.

### [Second Example of Processing Unit]

Referring to FIG. 6, in a second example of the processing unit 14, said unit comprises a comprises a loose material processing unit 42.

The loose material processing unit 42 is arranged to receive loose pre-precursor material from a container 6 and to process the pre-precursor material to derive the precursor material. The electrical circuitry 16 uses the preparation information read from the container 6 to control the loose material processing unit 42 to execute the preparation process.

A user presents manually the container 6 to a code reading system 18, of the machine 4, to read the code. The user then opens the container 6 and dispenses the pre-precursor material (not illustrated) arranged therein into the loose material processing unit 42. The loose material processing unit 42 processes the loose pre-precursor material to the precursor material.

In a particular example, the pre-precursor material is coffee beans, and the loose material processing unit 42 is arranged to roast and/or grind the coffee beans to provide a precursor material.

In variant embodiments, which are not illustrated, the loose material processing unit is alternatively configured, including: with a dispensing system to open and dispense the pre-precursor from the capsule for subsequent processing (e.g. it may include a cutting tool to cut open the container and an extractor such as a scop to extract the pre-precursor material); the pre-precursor material may be processed in the container and either dispensed from the container by the aforedescribed example or provided to a user in the container.

### [Code Reading System]

Referring to FIGS. 4A and 4B, the code reading system 18 is arranged to read a code 44 arranged on a closing member of the container 6. The code reading system 18 is integrated with the extraction unit 32 of first example of the container processing unit 20. The code 44 is read with the extraction unit 32 in the capsule extraction position (as shown in FIG. 4B).

The code reading system 18 includes an image capturing unit 46 to capture a digital image of the code 44. Examples of a suitable image capturing unit 46 include a Sonix SN9S102; Snap Sensor S2 imager; an oversampled binary image sensor; other like system.

The electrical circuitry 16 includes image processing circuitry (not illustrated) to identify the code in the digital image and extract preparation information. An example of the image processing circuitry is a Texas Instruments TMS320C5517 processor running a code processing program.

Referring to FIG. 5, the code reading system 18 is arranged to read a code 44 from an underside of a flange of the container 6. The code 44 is read based on rotation of the code 44 relative a code reader 46 of the code reading system 18. The code 44 is read with the extraction unit 32 in the capsule extraction position (as shown in FIG. 5), with the rotation mechanism 33 rotating the container 6.

The code reading system 18 includes a code reader 46 to capture a code signal of the code 44. Examples of a suitable image code reader 46 include a photo diode or other electrical componentry that can distinguish between dark an light elements of the code. In variant embodiments, which are not illustrated, the code reader can be implemented as the image capturing unit, as discussed above, or with another suitable reading system.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is alternatively implemented, e.g. the code reading system is arranged on the machine to read a code of a container that a user manually presents to the image capturing device. In further variant embodiments, which are not illustrated, the code reading system is arranged to read a code at a different location of the container, e.g. on a storage portion.

### [Control Electrical Circuitry]

Referring to FIG. 7, the electrical circuitry 16 is implemented as control electrical circuitry 48 to control the processing unit 14 to execute a preparation process. In the embodiment of FIG. 7, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 46 and to provide a control output to the processing unit 14, and; a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 44 is suitably adapted for the other examples of the processing unit 14, e.g.: for the second example of the container processing system the feedback system may be used to control speed of rotation of the capsule; for the loose material processing unit the feedback system may be used to implement control of grinding rate and/or a heating temperature.

### [Container]

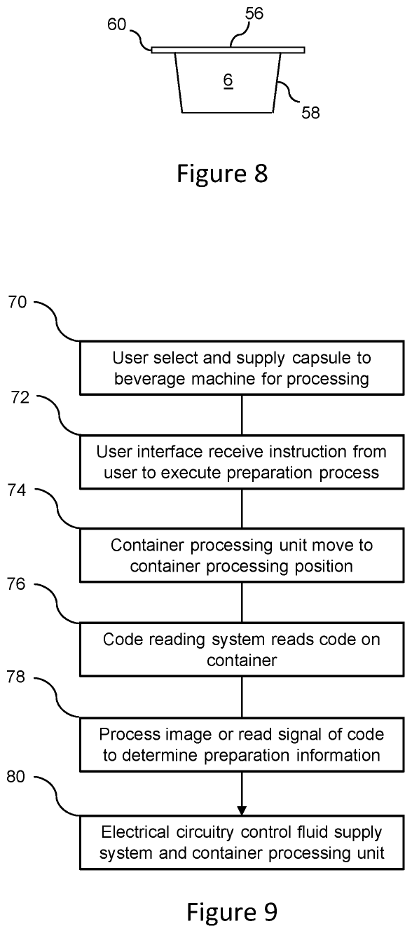

Referring to FIG. 8, an example of a container 6, that is for use with the first example or second example of the processing unit 14 comprises the container 6 arranged as a capsule. The capsule includes: a closing member 56; a storage portion 58, and; a flange portion 60.

The storage portion 58 includes a cavity for storage of the precursor material (not illustrated). The closing member 56 closes the storage portion 58 and comprises a flexible membrane. The flange portion 60 is arranged integrally with the storage portion 58 and presents a flat surface for connecting the closing member 56 to the storage portion 58 to hermetically seal the precursor material. The capsule 6 has a diameter of 2-5 cm and an axial length of 2-4 cm.

In variant embodiments, which are not illustrated, the container can have various shapes including: hemispherical; curved; rectangular in section; frustoconical, and; other like shapes. The closing member may be arranged as a rigid member, rather than a membrane. The container may be formed of two similar or identical storage portions that are connected at a flange, hence the closing member can me omitted. The flange may be connected to the storage portion, hence as separate components. The closing member may connect to the storage portion, hence the flange may be omitted.

Suitable examples of containers and/or closing members in terms of shapes, dimensions and/or materials are know from any of the cartridges, capsules and pods for portioned flavouring ingredients used by Nespresso™ (Original Line, Professional Line, Vertuo Line) and Nestle Dolce Gusto™ and Nestle Special-T™. The materials may thus include metal, for instance aluminium, plastic and/or paper. The materials are preferably biodegradable and/or recyclable. Suitable use, e.g. extraction, processes and systems are also known from Nespresso™, Nestle Dolce Gusto™ or Nestle Special-T™.

Constructional, manufacturing and/or (beverage) extraction details of containers and/or closing members are for instance disclosed in EP 2155021, EP 2316310, EP 2152608, EP2378932, EP2470053, EP2509473, EP2667757 and EP 2528485.

### [Arrangement of Code]

Referring to FIG. 8, the code 44 code is arranged on an exterior surface of the container 6 in any suitable position such that it can be read by the code reading system 18.

Referring to FIG. 8, the code 44 (not illustrated in FIG. 8) may be arranged on one or more of the following positions: the closing member 56; a lower surface of the flange portion 60 that faces away from the closing member 56; the storage portion 58.

### [Preparation Process]

Referring to FIG. 9, the execution of a process for preparing a beverage/foodstuff from precursor material is illustrated:

Block 70: a user supplies a container 6 to the machine 4.

Block 72: the electrical circuitry 16 (e.g. the input unit 50 thereof) receives a user instruction to prepare a beverage/foodstuff from precursor, and the electrical circuitry 16 (e.g. the processor 52) initiates the process.

Block 74: the electrical circuitry 16 controls the processing unit 14 to process the container (e.g. in the first or second example of the container processing unit 20, the extraction unit 32 is moved from the capsule receiving position (FIG. 4A) to the capsule extraction position (FIG. 4B, FIG. 5)).

Block 76: the electrical circuitry 16 controls the code reading system 18 to read the code 44 on the container 6 and provide a digital image of the code or an code signal related to the code.

Block 78: the code processing circuitry of the electrical circuitry 16 processes the digital image to or code signal extract the preparation information.

Block 80: the electrical circuitry 16, based on the preparation information, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction position though the capsule ejection position to eject the container 6 and back to the capsule receiving position.

In variant embodiments, which are not illustrated: the above blocks can be executed in a different order, e.g. block 72 before block 70 or block 76 before block 74; some block can be omitted, e.g. where a machine stores a magazine of capsules block 70 can be omitted; alternatively at blocks 70 to 76 a user presents the code of the container to the code reading system and after it is read opens said container and dispenses the pre-precursor material into the processing unit. Moreover, the container processing unit may be manually moved between the extraction position and capsule receiving position.

Blocks 76 and 78 may be referred to a code reading and processing process. Block 80 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

### [Code General Description]

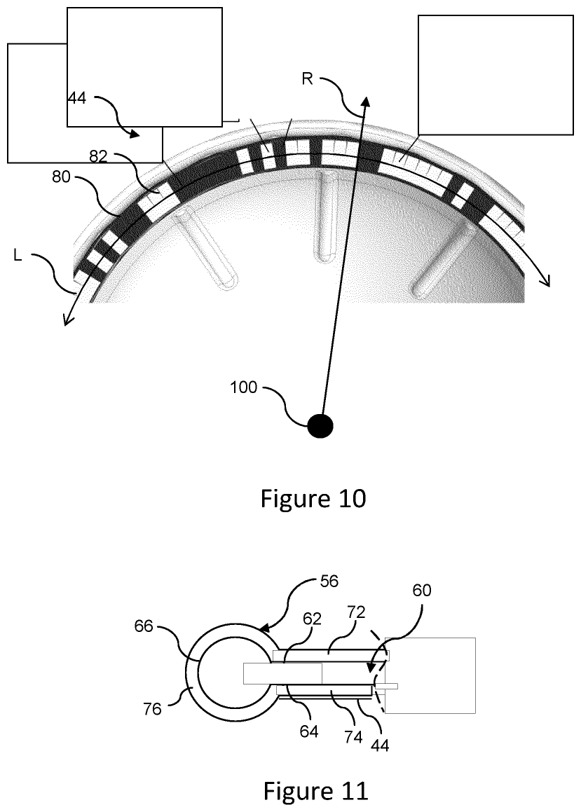

Referring to FIG. 10, the code 44 is formed of a plurality of elements 80. The elements 80 are arranged on a surround 82. The elements 80 are a dark colour (e.g. including one of the following: black, dark blue, purple, dark green) and the surround 82 is a comparatively light colour (e.g. including one of the following: white, light blue, yellow, light green) such that there is sufficient contrast for the image capturing unit 46 to distinguish therebetween. In variant embodiments, which are not illustrated: the elements are a light colour and the surround is a dark colour.

The elements 80 are formed by printing e.g. by means of an ink printer. As an example of printing the ink may be conventional printer ink and the substrate may be the container outer surface including one of the closing member, flange or storage portion, or a separate substrate, which is connected to the container. In variant embodiments, which are not illustrated, the elements are alternatively formed, including by embossing, engraving or other suitable means.

The elements 80 have various shapes as will be discussed. As used herein the term “shape” in respect of the elements may refer to an exact shape or an approximation of the actual shape, which can occur to a printing or other manufacturing variations in precision.

The elements 80 are arranged to be read sequentially when the container is rotated about an axis of rotation 100 (as also illustrated in FIG. 5). The elements 80 of the code 44 are arranged on a circumferentially extending virtual line L.

### [Code Encoding]

The elements 80 encode a data portion for storing the preparation information, and encode a finder sequence for locating the data portion. The elements 80 are encoded as a bit code, wherein the absence or presence of an element encodes a logical 1 or a 0.

The finder sequence (not illustrate) comprises a predefined reserved sequence of logical 1s and/or 0s, which is identifiable when processing the code. The data sequence is arranged at a known position with respect to the finder sequence, e.g. immediately after or distributed within the finder sequence. Hence with the finder sequence located, the data sequence can then be located read and decoded. The data sequence may be decoded based on a rule stored on the electrical circuitry 16 (e.g. via electronic memory) of the machine 2. A specific example of such a code is provide in EP 2594171 A1.

### [Container Formation]

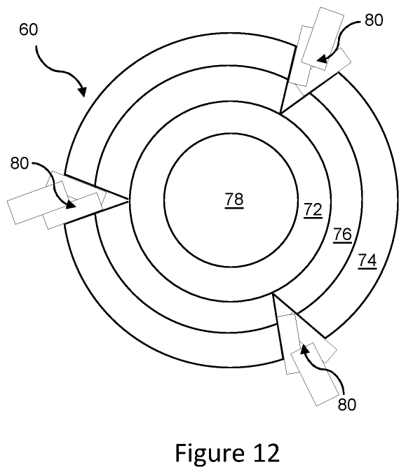

Referring to FIGS. 11 and 12, which is a more detailed example that implements the features discussed in association with the embodiments of FIGS. 8 and 10. The flange 60 includes an upper surface 62, an opposed lower surface 64, and a peripheral edge 66. The membrane 56 is arranged to extend: over the upper surface 62; around the peripheral edge 66, and; over the lower surface 64, of the flange 60.

In particular: an upper surface portion 72 of the membrane 56 extends over the upper surface 62 of the flange 60; a lower surface portion 74 of the membrane 56 extends over the lower surface 64 of the flange 60, and; an edge portion 76 of the membrane 56 extends over the edge 66 of the flange 60. A closing portion 78 of the membrane 56 extends over an opening of the storage portion 58 (shown in FIG. 8).

The code 44 is arranged on the lower surface portion 74 of the membrane 56, which adjoins the lower surface 64 of the flange 60.

In variant embodiments, which are not illustrated, the code can be alternatively arranged including on one or more of the following portions of the membrane: the lower surface portion; the upper surface portion; the edge portion, and; the closing portion. In systems 2 that have a single preparation process programmed into the machine 4, the code may also be omitted from the container.

The membrane 60 is physically connected to at least one of: the upper surface 62; the lower surface 64, and; the peripheral edge 66 of the membrane 60. In particular it is physically connected by an adhesive to the lower surface 64.

Referring to FIG. 12, the membrane 60 includes three formation portions 84, which are arranged on the edge portion 76 and lower surface portion 74. The formation portions 84 comprise triangular shaped cut-outs that enable expansion as the edge portion 76 is expanded over the edge 56 of the flange 60 and contraction as the lower surface portion 64 is contracted over the lower surface 64 of the flange 60. The formation portions 84 facilitates more convenient wrapping of the membrane, e.g. without unpredictable tearing or wrinkling of the membrane.

In variant embodiments, which are not illustrated, the formation portions are alternatively arranged including as: other numbers of formations, e.g. any number greater than two; the cut-outs may be shaped other than as triangular, including as convex or concave curved, U-shaped etc; the formation portion may be formed as perforations or scores or other points of weaking arranged to encourage expansion or contraction of the material, and; the formation portions are formed only on one of the edge portion or lower surface portion.

In other variant embodiments, which are not illustrated, the membrane is formed of a material, such as a plastic based material, examples of which are previously provided, that is able to expand and contract around the flange without rupturing or wrinkling.

Referring back to FIG. 11, the peripheral edge 66 of the flange 60 is arranged to be generally circular, and can be formed by rolling of the edges of the flange. In this manner the edge portion 76 of the membrane 56 can extend around the circular section without the comparatively sharper unrolled edge perforating or otherwise damaging the membrane 60.

In other variant embodiments, which are not illustrated, the circular edge can be omitted (and therefore the process of rolling the flange to form said edge is obviated) since the comparatively sharper unrolled edge it is covered by and structurally reinforced by the membrane.

A method of assembling the contain 6 associated with the embodiment of FIGS. 8, 11 and 12 comprises the following steps:

Step 1: arranging the upper surface portion 72 of the membrane 56 over the upper surface 62 of a flange 60 (as part of this step the closing portion 78 of the membrane 56 can also be arranged over the opening of the storage portion 58).

Step 2: wrapping the edge portion 76 of the membrane 56 around the edge 66 of the flange 60

Step 3: arranging the lower surface 74 of the membrane 56 over the lower surface 64 of the flange 60.

Step 4: connecting the membrane 56 to the flange 60 (e.g. via an adhesive connection between the lower surface 74 of the membrane 56 over the lower surface 64 of the flange 60).

Step 5: forming the code 44 on the lower surface 74 of the membrane 56.

In variant embodiments, the method includes forming the code on the membrane before the membrane is connected to the flange. In this way the code is easier to print on the membrane since the membrane is arranged in 2-dimmensions prior to wrapping around the flange. In a further embodiment, the code can be formed on a separate substrate and fixed to the lower surface portion (or other portion) of the membrane.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
   4 Machine
      14 Processing unit
         20 Container processing unit (first/second example)
         32 Extraction unit
         34 Capsule holding portion
         36 Closing portion
         38 Injection head
         40 Beverage outlet
         33 Rotation mechanism
         37 Drive system
         22 Fluid conditioning system
         24 Reservoir
         26 Pump
         28 Heat exchanger
         30 Outlet
         42 Loose material processing unit
      16 Electrical circuitry
         48 Control electrical circuitry
         50 Input unit
         52 Processor
         54 Feedback system
      18 Code reading system
         46 Image capturing unit
   6 Container (Capsule)
      56 Closing member (membrane)
         72 Upper surface
         74 Lower surface
         76 Peripheral edge (Rim)
         78 Closing portion
         80 Formation portions
      58 Storage portion
      60 Flange portion
         62 Upper surface
         64 Lower surface
         66 Peripheral edge (Rim)
      44 Code
         80 Elements
         L Virtual line
         82 Surround
      100 Axis
      R Radial direction
   8 Server system
   10 Peripheral device
   12 Computer network

1. A container arranged for containing a precursor material for use with a machine for preparing a beverage and/or foodstuff, the container comprising:
a storage portion having an opening for receiving the precursor material, the storage portion extending in a depth direction from said opening;
a membrane to close the opening;
a flange including an upper surface, an opposed lower surface arranged at a greater depth than the upper surface, and a peripheral edge, and;
a machine-readable code storing preparation information for use with a preparation process performed by said machine,
the membrane is arranged to extend: over the upper surface; around the peripheral edge, and; over the lower surface, and
the code is arranged on a lower surface portion of the membrane, which adjoins the lower surface of the flange.

2. The container of claim 1, wherein the membrane is physically connected to at least one of: the upper surface; the lower surface, and; the peripheral edge of the flange.

3. The container of claim 1, wherein the membrane includes formation portions arranged on the portion adjoining the lower surface, said portions configured to enable expansion and/or contraction as the membrane is wrapped around said peripheral edge.

4. The container of claim 1, wherein the peripheral edge is circular in cross-section, a peripheral edge portion of the membrane is arranged to extend around said circular-cross section.

5. The container of claim 1, wherein the upper surface and an opposed lower surface have a radial length of less than 5 mm and the peripheral edge has a radius of less than 2 mm, wherein a material of the membrane is selected to extend over said radii without overlapping portions.

6. The container of claim 1, wherein the membrane is made of a plastic based material.

7. The container of claim 1, wherein the membrane has a thickness of 0.25 mm-4 mm.

8. The container of claim 1, wherein a peripheral edge portion of the membrane comprises the code.

9. The container of claim 1, wherein the code is arranged to be readable as the container is rotated about an axis of rotation.

10. A system comprising a container of arranged for containing a precursor material for use with a machine for preparing a beverage and/or foodstuff, the container comprising:
a storage portion having an opening for receiving the precursor material, the storage portion extending in a depth direction from said opening;
a membrane to close the opening;
a flange including an upper surface, an opposed lower surface arranged at a greater depth than the upper surface, and a peripheral edge;
a machine-readable code storing preparation information for use with a preparation process performed by said machine,
the membrane is arranged to extend: over the upper surface; around the peripheral edge, and; over the lower surface, and the code is arranged on a lower surface portion of the membrane, which adjoins the lower surface of the flange and a machine for preparing a beverage and/or foodstuff, the machine including:
a code reading system to read the code of the container;
a processing unit for processing the precursor material of the container, and;
electrical circuitry to control the processing unit based on preparation information read from the code.

11. (canceled)

12. A method of forming a container for containing a precursor material for use with a machine for preparing a beverage and/or foodstuff, the method comprising:
arranging a membrane over an upper surface of a flange, said flange being connected to a storage portion, the storage portion extending in a depth direction from the flange;
wrapping the membrane around a peripheral edge of the flange, said peripheral edge adjoining the upper surface;
arranging the membrane over a lower surface of the flange, said lower surface adjoining the peripheral edge and arranged at a greater depth than the upper surface;
connecting the membrane to the flange, and
forming the code on the membrane that extends over the lower surface.

13. (canceled)
